(19) United States
(12) Patent Application Publication
(10) Pub. No.: US 2005/0267927 A1
(43) Pub. Date: Dec. 1, 2005

(54) System for managing telecommunication asset information

(76) Inventors: Timothy D. Wise, Marietta, GA (US); Brian S. Fogle, Duluth, GA (US)

Correspondence Address: BRYAN W. BOCKHOP, ESQ., 2375 MOSSY BRANCH DR., SNELLVILLE, GA, 30078, US

(21) Appl. No.: 10/856,488

(22) Filed: May 28, 2004

(51) Int. Cl. G06F 15/16

(52) U.S. Cl. 709/200

(57) ABSTRACT

A telecommunications asset information management system includes a server, a data entry object and a store request object. The server is capable of receiving and storing in a database at a location that is remote from the first location communications network service-specific data that is specific to a predetermined network service. The predetermined network service is in communication with a specific set of customer premise equipment employed by an entity associated with the user. The data entry object includes a plurality of communications network service-specific data fields and allows input of communications network service-specific data into the communications network service-specific data fields. The user may transmit the communications network service-specific data to the server to be saved into a database.

### BACKGROUND OF THE INVENTION

1. Field of the Invention

The present invention relates to management systems and, more specifically, to a system that manages communications asset information.

2. Description of the Prior Art

Current communications systems include a host of different options for an enterprise to manage. A typical enterprise will own or lease numerous pieces of communications equipment (including telephone sets, data routing equipment, mobile telephones and other types of physical equipment) and will interconnect these pieces of equipment through numerous communications channels (including telephone lines, data lines, wireless systems and other types of communications channels). The equipment used by an enterprise usually communicates with the outside world via one or more communications network services (including Internet, private computer network, local telephone service, long distance telephone service, mobile services and several other types of communication service). The enterprise may administer exchange services, or it may use similar services supplied by a telephone company, or other communications service providers.

For example, a private branch exchange (PBX) is a telephone system within an enterprise that switches calls between enterprise users on local lines while allowing all users to share a certain number of external phone lines. A PBX saves the cost of requiring a line for each user to the telephone company's central office. The PBX is owned and operated by the enterprise rather than the telephone company, which may be a supplier or service provider. Typically, a PBX includes a telephone trunk line, multiple phone lines that terminate at the PBX and a network of lines within the PBX. A computer with memory manages the switching of the calls within the PBX and into and out of the PBX. A PBX also often includes a console or switchboard for a human operator. Alternatives to a PBX include Centrex service (in which a pool of lines is rented at a telephone company's central office), key telephone systems, and integrated services digital network (ISDN), usually for small enterprises.

A switched virtual circuit (SVC) is a temporary virtual circuit that is set up and used only as long as data is being transmitted between two hosts (or locations). Once the communication between the two hosts is complete, the SVC disappears. In contrast, a permanent virtual circuit (PVC) remains available at all times.

A frame relay is a packet-switching protocol for connecting devices on a wide area network (WAN). Frame relay networks in the U.S. support data transfer rates at T-1 (1.544 Mbps) and T-3 (45 Mbps) speeds. A frame relay is essentially a way of utilizing existing T-1 and T-3 lines owned by a service provider. Most telephone companies provide frame relay service for customers who want connections at 56 Kbps to T-1 speeds. (In Europe, Frame Relay speeds vary from 64 Kbps to 2 Mbps. In the U.S., frame relay service is quite popular because it is relatively inexpensive.

Asynchronous transfer mode (ATM), is a multi-service, high speed, scalable technology. It is a dominant switching fabric in carrier backbones, supporting services with different transfer characteristics. ATM simultaneously transports voice, data, graphics and video at very high speeds. Large enterprises are increasingly connecting headquarters and main offices to the wide area network via broadband links such as ATM to accommodate their vast amounts of voice and data transmissions, such as heavy graphics, payroll information and voice and video conferencing.

Administering an enterprise's communications systems can be a daunting task. Each piece of equipment has its own serial number and other identifiers (such as model number and operating characteristics) associated with it. Each service has an associated account number, a termination point, and various other operating characteristics. Existing communications management systems include simply storing relevant information in paper files and storing the information in ad hoc data files (such as spreadsheets). These systems often break down when a critical employee (such as one who knows the location of the important data, or one who knows the password needed to access the data files) leaves the enterprise. They also break down when a user, who is remote from the data storage data, needs critical data.

Therefore, there is a need for a system that provides a guided method of storing and retrieving data about communications systems.

There is also a need for a system that facilitates access to data about communications systems to users in various locations.

### SUMMARY OF THE INVENTION

The disadvantages of the prior art are overcome by the present invention which, in one aspect, is a telecommunications asset information management system that is operated by a user, at a first location, having access to a computer in communication with a computer network. The computer is also in communication with a display. The system includes a server, a data entry object and a store request object. The server is in communication with the computer network and is capable of receiving and storing in a database at a location that is remote from the first location, via a computer network, communications network service-specific data that is specific to a predetermined network service. The predetermined network service is in communication with a specific set of customer premise equipment employed by an entity associated with the user. The data entry object is capable of being displayed on the display and includes a plurality of communications network service-specific data fields. The data entry object allows the user to input the communications network service-specific data into the communications network service-specific data fields. The store request object allows the user to transmit the communications network service-specific data to the server and instructs the server to save the communications network service-specific data into the database.

In another aspect, the invention is a method of managing information relating to a plurality of telecommunications assets via a computer network accessible to a computer in communication with a display and operated by a user. A first computer-generated data interface that includes a plurality of communications network-specific data fields is generated on the display. Each communications network-specific data field is capable of receiving and displaying communications network assets data associated with a first location. A second location that is remote from the first location, via the computer network, the communications network assets data is transmitted to a server. The server is instructed to store the communications network assets data in a database on the server. A request for communications network assets data to be displayed on the display is transmitted to the server. The communications network assets data displayed on the display after the communications network assets data is received from the server.

In yet another aspect, the invention is a method of managing, via a computer network accessible to a computer in communication with a display and operated by a user at a first location, information relating to a plurality of telecommunications assets. Customer premise equipment-specific data that is specific to a predetermined private virtual circuit in communication with a specific set of customer premise equipment employed by an entity associated with the user is received via a computer network and stored in a database at a location that is remote from the first location. A request for customer premise equipment-specific data is received from the user. In response to the receiving step, the customer premise equipment-specific data is transmitted to the user.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a hardware configuration that may be used according to one embodiment of the invention.

FIG. 2 is a schematic diagram of a communications network.

FIG. 3 is a schematic diagram showing a portion of a communications network at a first location.

FIG. 4 is a schematic diagram showing a sub-portion of a communications network at a first location.

FIGS. 5A-5W is a plurality of screen views showing a corresponding plurality of guided data entry and display objects.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

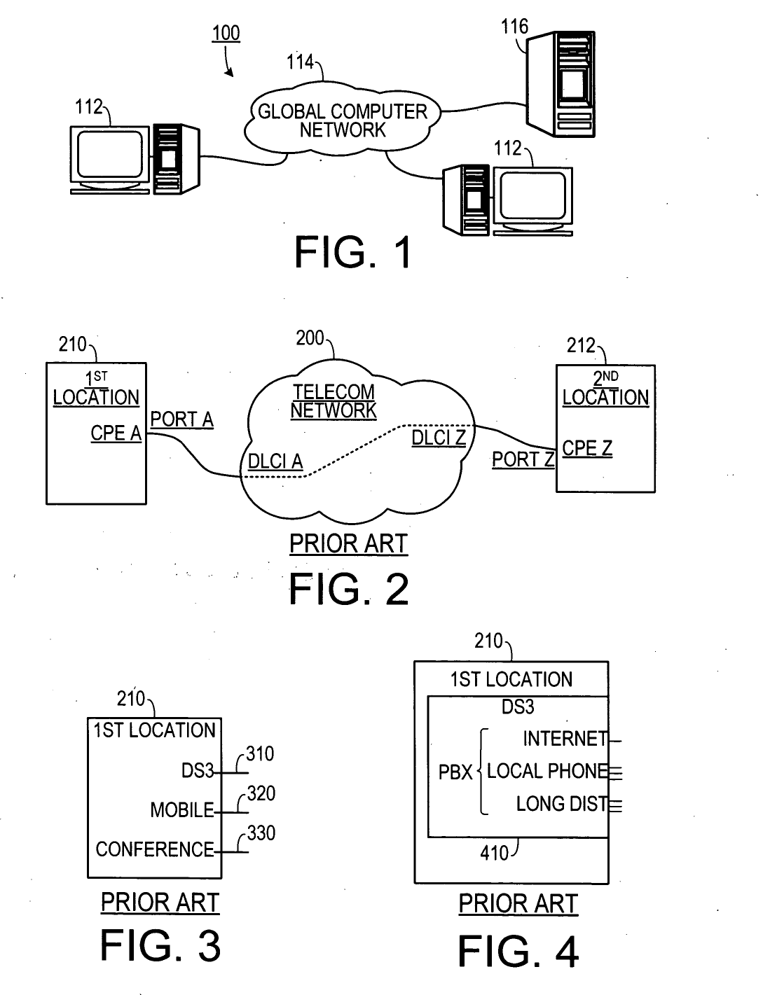

As shown in FIG. 1, one embodiment 100 of the invention includes a plurality of computers 112, each in communication with a display and operable by a user, that are in data communication with a computer network 114, which could include a global computer network, a local network, virtual private network, or any other network that allows data communication between computers 112. Also in data communication with the computer network 114 is a server 116 that is capable of sending and receiving data to and from the computer network 114 and that is capable of storing data that has been received in a database (e.g., a relational database).

Typically, the invention manages data relative to a communications network, as shown in FIG. 2, in which a telecommunications network 200 interconnects the first location 210 with a second location 212. (As used herein, “telecommunications network” includes networks that facilitate data communication, voice communication and other types of information communication, and can include analog or digital channels, or a combination thereof.) The first location 212 would be the site of various customer premise equipment (CPE) and is usually designated with the letter “A” to signify a starting place. The CPE at the first location 210 is designated CPE A and communicates with the network 200 through a port designated as PORT A. Typically, the network service provider receives information from PORT A at a data link that is labeled with a data link connection identifier (DLCI). A DLCI can include a number of private or switched virtual circuits in a frame relay network that tells the frame relay how to route data through the network. The DLCI typically identifies which logical circuit data travels over. Typically, for administrative convenience, a user will designate a DLCI at a first location 210 in a circuit as DLCI A and a DLCI at a second location as DLCI Z. As shown in FIG. 3, the CPE at a location, such as the first location 210, could include such service equipment as a DS3 line 310, a mobile access 320 and conference calling equipment 330. As shown in FIG. 4, DS3 services available could include a private branch exchange (PBX) 410, which could include (but is not limited to) digital Internet service, local phone service and long distance service.

Returning to FIG. 1, the server 116 is capable of receiving and storing in a database at a location that is remote from the first location, via the computer network 114, communications network service-specific data that is specific to a predetermined network service in communication with a specific set of customer premise equipment employed by an entity associated with the user.

The telecommunications asset information management system includes a data entry object, which takes the form of one or more guided data entry screens, or other types of computer generated data interfaces, displayed on the display. The screens include a plurality of communications network service-specific data fields that allows the user to input the communications network service-specific data into the communications network service-specific data fields. A store request object, such as a drop-down “File: Save” command or a “store” button, allows the user to transmit the communications network service-specific data to the server and instructs the server to save the communications network service-specific data into the database. The communications network service-specific data includes customer premise equipment-specific data and network service-specific data.

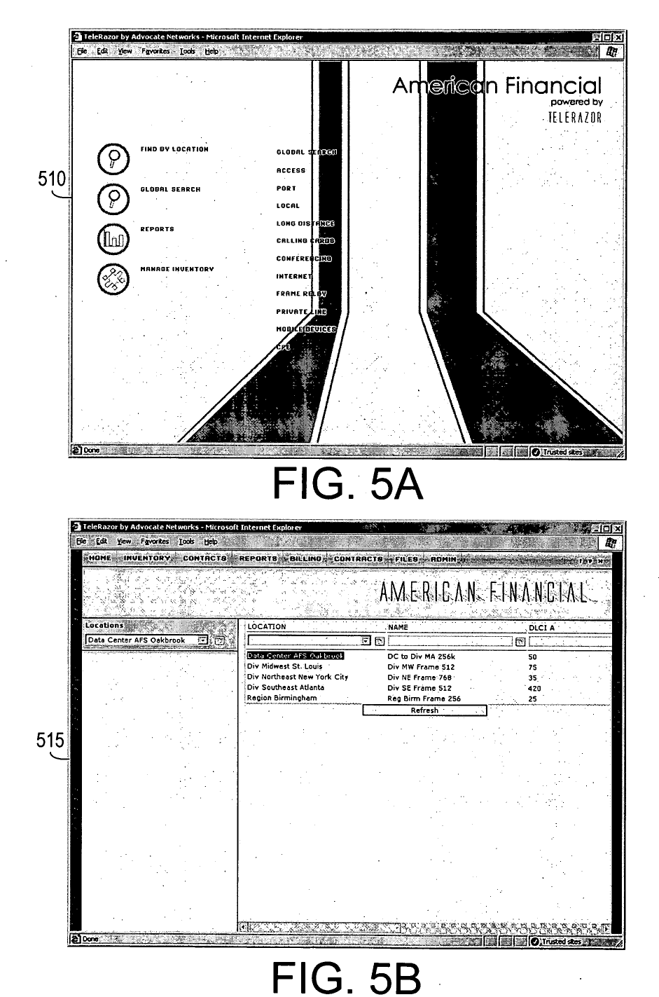

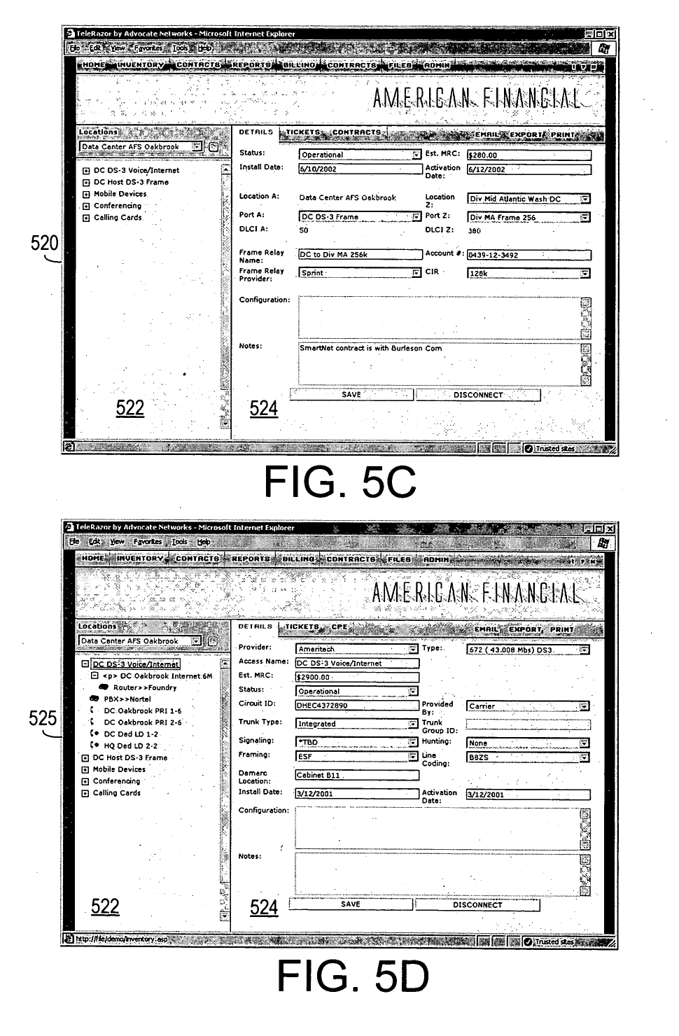

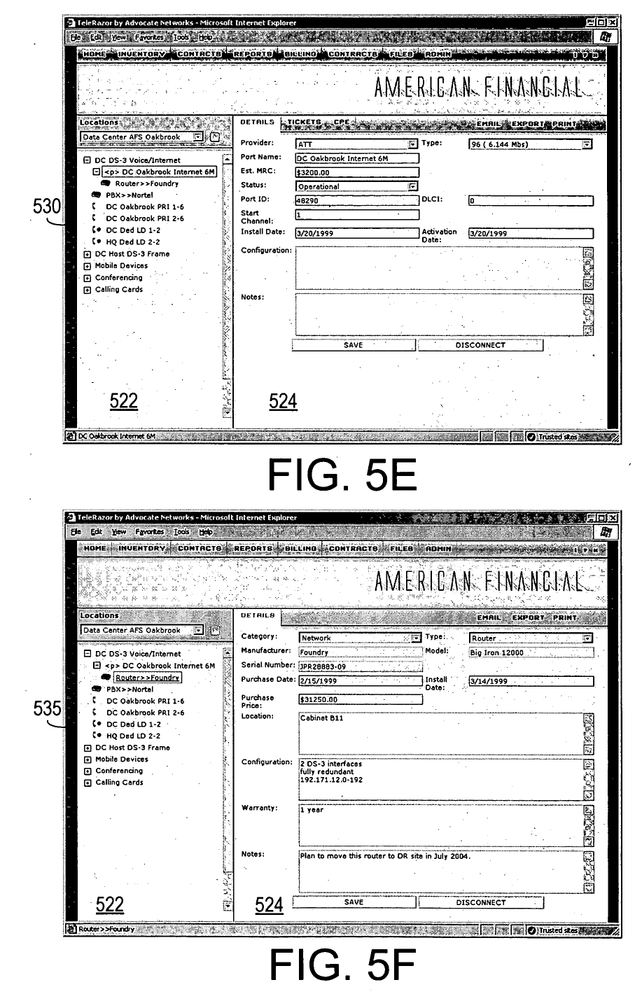

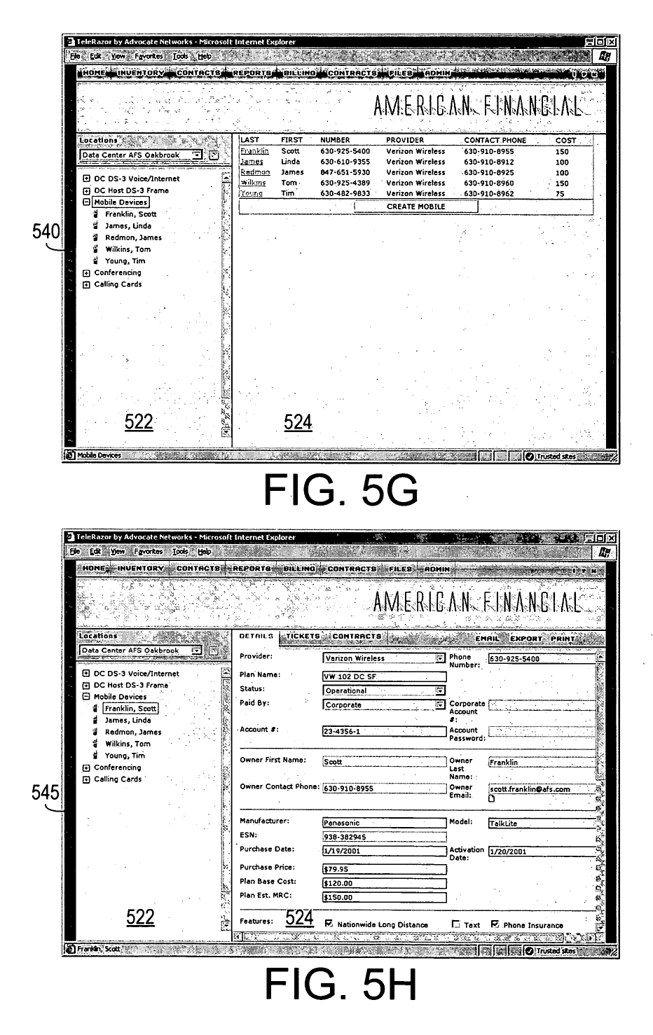

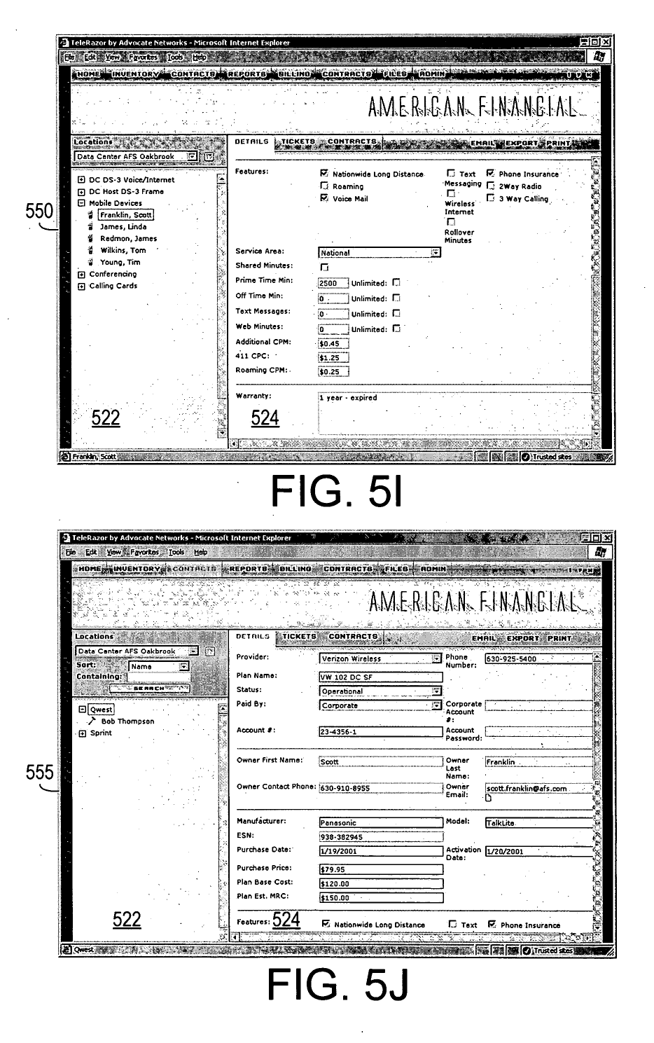

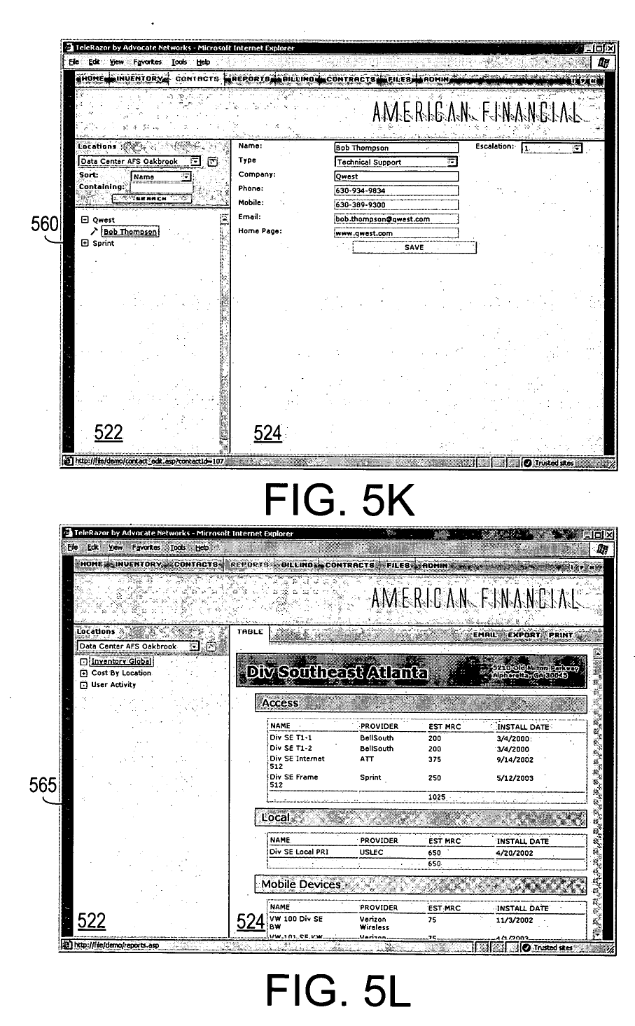

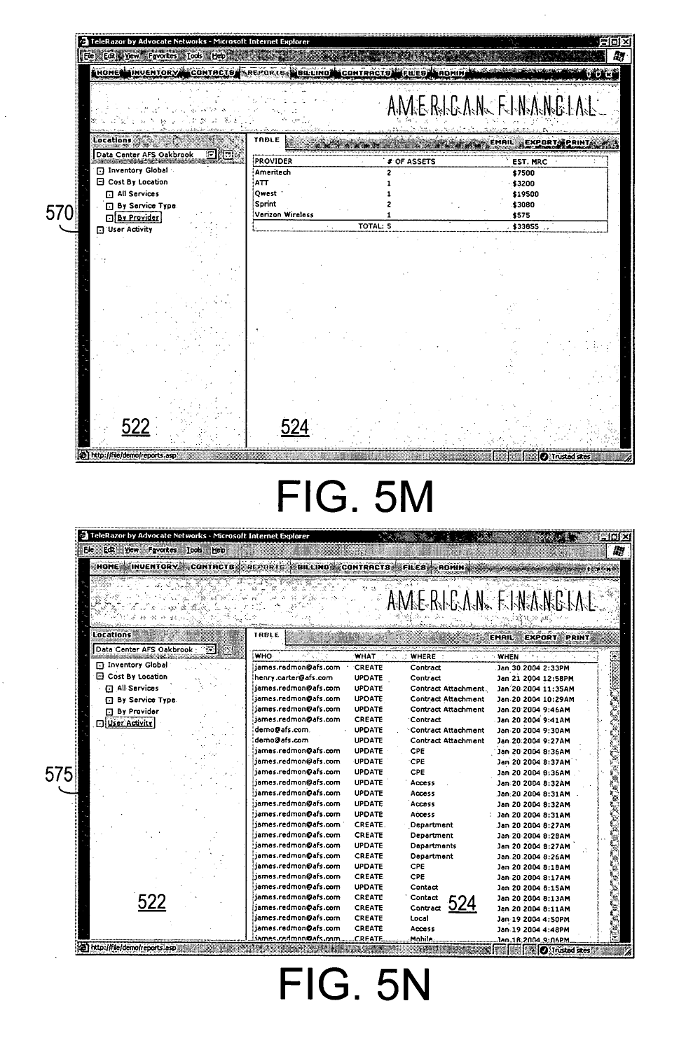

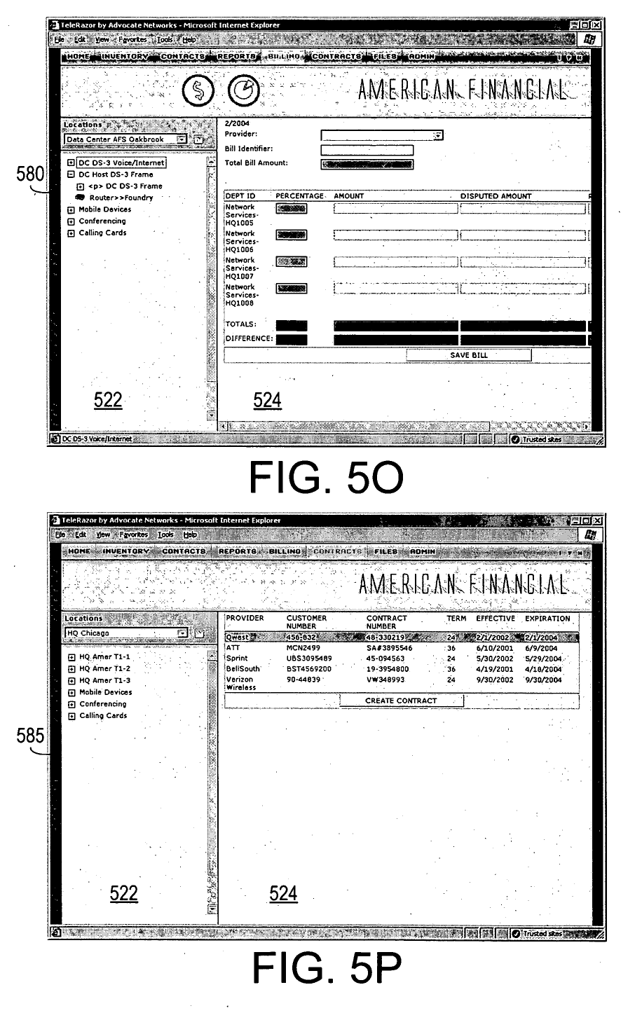

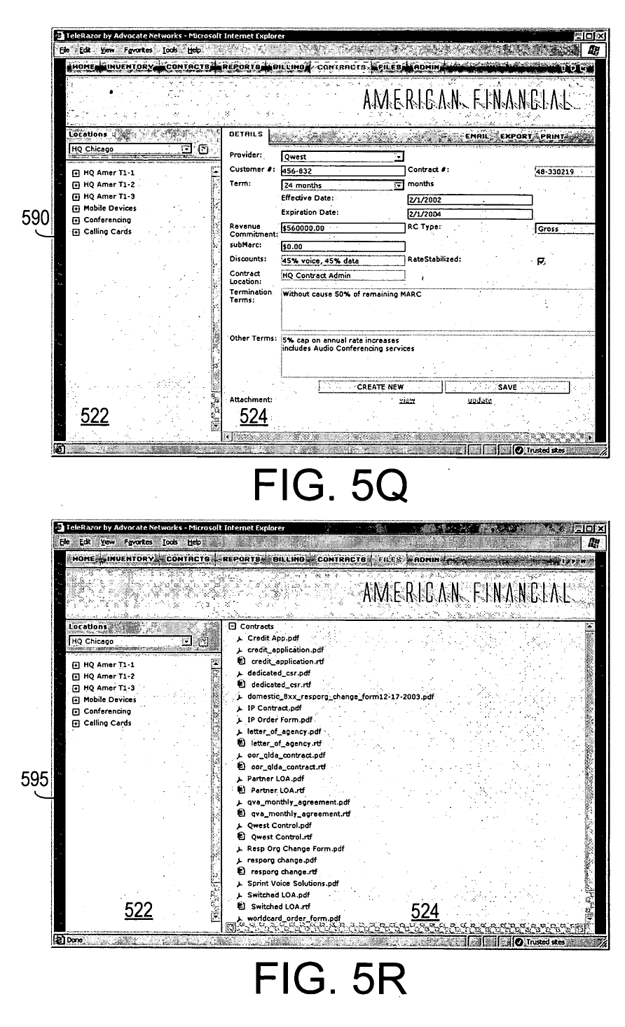

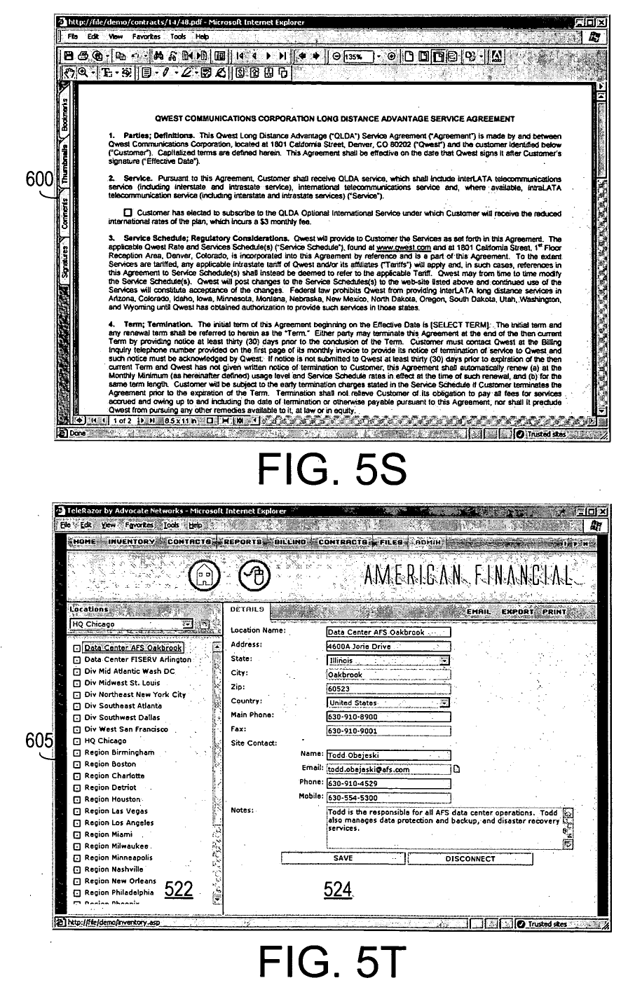

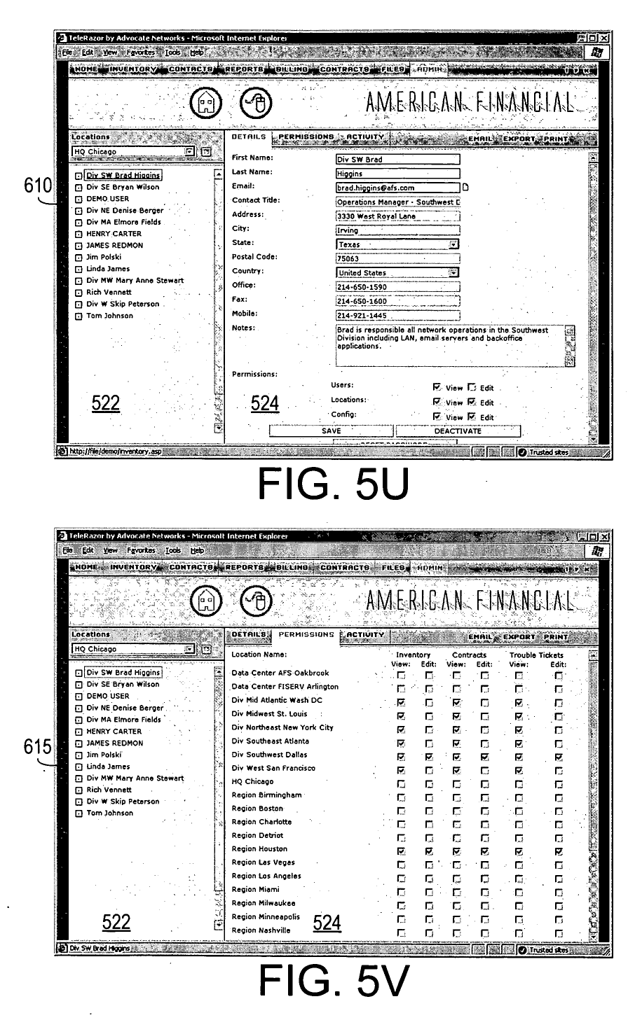

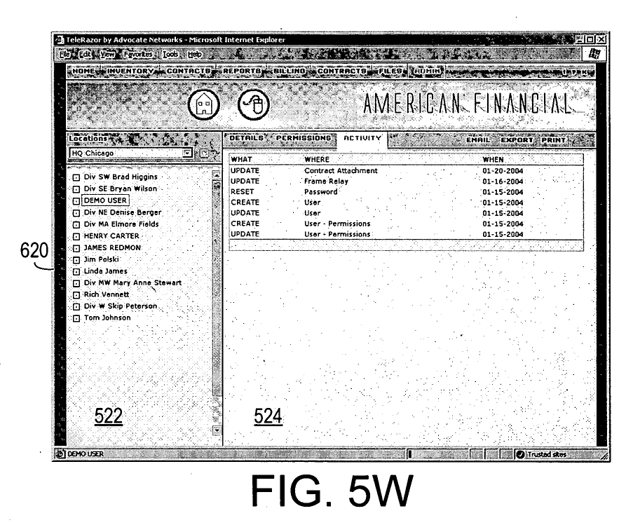

As shown in FIGS. 5A-5W, the invention may be embodied with a browser-based user interface. For example, as shown in FIG. 5A, an initial entry screen 510 allows the user to access a variety of other screens, according to the user's needs. For example, entry screen 510 allows a user to navigate, by pointing and clicking a mouse, to data screens relating to such network services as: local access, ports, local voice service, long distance service, calling cards, conferencing services, Internet service, frame relay service, private lines, mobile devices and CPE. As is understood to those of skill in the art, many other types of service (e.g., private virtual circuits and ATM) may also be included. This screen also allows the user to navigate to search screens and reports screens. A high level data screen 515 is shown in FIG. 5B. This data screen 515 may show information about high level services relating to specific locations. It may show such information as the name of a location, the name of a corresponding circuit and a DLCI A designation for the corresponding circuit.

From screen 515, the user may click on a specific location to get a screen 520 that includes more detailed information about the location, as shown in FIG. 5C, including high lever primary asset information. Screen 520 may include a plurality of primary customer premise equipment-specific data fields. Each primary customer premise equipment-specific data field is capable of receiving and displaying primary customer premise equipment-specific data relating to a primary telecommunications asset at the selected location. The data fields can include, for example: a Port A identifier field, a Port Z identifier field, a frame relay identifier field, a frame relay account identifier field, a frame relay provider name field, a location of a Port A termination at the first location field and a location of a Port Z termination at the second location field. The Port A termination at the first location field and the location of the Port Z termination at the second location field may be displayed as waterfall menus, where each waterfall menu provides a plurality of predetermined allowable options for each field. Screen 520 may also include, for example, a current status indicator of the service or asset, an estimated monthly recurring cost (MRC), an installation date, an activation date, a data rate and a notes field, such as a configuration notes field, which stores information about the specific configuration being used, and a general notes field.

In one exemplary organizational scheme, the data interface screens, for example screen 520, may be organized to include an location data field 522 that allows the user to select a desired location from a plurality of locations, with each location listed being expandable to a plurality of sub-categories of assets at a location (as shown in FIG. 5D, et seq.) and an interactive region 524 that displays interactive data fields, such as an identification of each of a plurality of primary telecommunications assets associated with the selected location, as shown in FIG. 5C.

By expanding a location in the location data field 522, relating to a primary telecommunications asset, a plurality of secondary telecommunications asset screens relative to selected sub-categories of services or equipment may be displayed. For example, as shown in FIG. 5D, a secondary telecommunications asset-specific screen 525 may be displayed. Screen 525 may include a plurality data fields allowing display and data entry regarding a secondary asset, such as specific CPE. Such screen 525 may include data fields corresponding to a provider name field that identifies the provider of the CPE, and a circuit identification field that identifies the circuit designation assigned by the provider to the telecommunications asset. Screen 525 may also include such fields for such information as: a user-assigned access name field that identifies the secondary telecommunications asset, a demarcation location data field that identifies a physical location of a termination point of the secondary telecommunications asset, a signaling type data field that identifies a signaling type employed by the secondary telecommunications asset, a trunk type data field that identifies a trunk type employed by the secondary telecommunications asset, a framing type data field that identifies a framing type employed by the secondary telecommunications asset, a line coding type data field that identifies a line coding standard employed by the secondary telecommunications asset, an install date data field that identifies a date on which the secondary telecommunications asset was installed, and an activation date data field that identifies a date on which the secondary telecommunications asset was activated.

As screen 530 about a specific service, as shown in FIG. 5E, may be selected by the user. This screen 530 could include data fields such as: the name of the provider, the data rate of the service, the name of the port and port identification where the service terminates a selected location, the estimated monthly recurring charges associated with the service, the operational status of the service, the DLCI associated with the service, the start channel, the install date, the activation date and various notes fields.

The user may select a screen 535, as shown in FIG. 5F, that displays a plurality of tertiary telecommunications equipment-specific data fields, where each telecommunications equipment-specific data field is capable of receiving and displaying telecommunications equipment-specific data relating to a telecommunications equipment asset that is associated with a primary telecommunications asset. Te plurality of tertiary telecommunications equipment-specific data fields could include the following: an equipment category indicator field that accepts a category describing the telecommunications equipment asset, an equipment type indicator field that accepts an equipment type describing the telecommunications equipment asset, a serial number field that accepts a serial number for the telecommunications equipment asset, and a model name field that accepts a model name for the telecommunications equipment asset. Other information may also be displayed, includes: a purchase date field that accepts a purchase date for the telecommunications equipment asset, an installation date field that accepts an installation date for the telecommunications equipment asset, a purchase price field that accepts a purchase price for the telecommunications equipment, a configuration notes field that accepts configuration information relating to the telecommunications equipment asset, and a warranty notes field that allows input of warranty information relating to the telecommunications equipment asset.

A screens 540, 545, 550, and 555 as shown in FIGS. 5G-5J, may show a plurality of mobile device data fields, each associated with a mobile device. These fields may include such information as: a mobile telephone number field that identifies a telephone number of the mobile device, a mobile provider identification field that identifies a mobile service provider associated with the mobile device, a mobile service plan identifier field that identifies a mobile service plan associated with the mobile device, a mobile plan account number field that identifies an account number associated with the mobile device, a mobile device user identification field that identifies a mobile device user, a mobile device user contact information field that stores contact information associated with the mobile device user, a mobile device manufacturer identification field that identifies a manufacturer of the mobile device, a mobile device model identification field that identifies a model of the mobile device, and a mobile device serial number identification field that identifies a serial number of the mobile device. Further information about mobile services included in these screens could include a mobile device cost information field that indicates cost information associated with the mobile device and a mobile device account information field that indicates account information associated with the mobile device. Screen 560, as shown in FIG. 5K, may show information about a specific user of a mobile service.

As shown in FIG. 5L, a screen 565 a global inventory listing of all telecommunications assets owned by the entity associated with the user. As shown in FIG. 5M, screen 570 may show asset cost data. For ease of use, the system may capable of sorting the information on these screens by provider name, by service type or by other user-selected criteria, using known sorting algorithms.

Several administrative information screens may be selected by the user. For example, as shown in FIG. 5N, a screen 575 may include a user activity listing that lists a plurality of activities performed by the user. A billing activity listing screen 580, as shown in FIG. 5O, lists a plurality of billing activities associated with a telecommunications asset. An provider listing screen 585, as shown in FIG. 5P, lists service providers, corresponding contract numbers and other relevant information. If a specific provider is selected, the user can bring up a contract listing screen 590, as shown in FIG. 5Q, that may list a plurality of telecommunications asset contract information units associated with telecommunications contracts to which the entity associated with the user is a party. A document retrieval screen 595, as shown in FIG. 5R, includes a plurality of links to computer-stored documents. When the user clicks on a listed document, the document 600 will be displayed, a shown in FIG. 5S. A contact information screen 605, as shown in FIG. 5T, may list contact information about people responsible for telecommunications assets at given locations. Permissions screens 610 and 615 (which is a scrolled-down view of screen 610) as shown in FIGS. 5U and 5V, respectively, can allow security control relative to various users. A recent activity screen 620, as shown in FIG. 5W, can provide an audit trail of system activity attributable to specific users. As will be understood by those of skill in the art, many other types of screens may be displayed, showing other types of information, without departing from the scope of the invention.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

1. A telecommunications asset information management system that is operated by a user, at a first location, having access to a computer in communication with a computer network, the computer also in communication with a display, the system comprising:
a. a server, in communication with the computer network, that is capable of receiving and storing in a database at a location that is remote from the first location, via a computer network, communications network service-specific data that is specific to a predetermined network service in communication with a specific set of customer premise equipment employed by an entity associated with the user;
b. a data entry object, capable of being displayed on the display, that includes a plurality of communications network service-specific data fields and that allows the user to input the communications network service-specific data into the communications network service-specific data fields; and
c. a store request object that allows the user to transmit the communications network service-specific data to the server and that instructs the server to save the communications network service-specific data into the database.

2. The telecommunications asset information management system of claim 1, wherein the communications network service-specific data includes customer premise equipment-specific data and network service-specific data.

3. The telecommunications asset information management system of claim 1, wherein the network service comprises a local access.

4. The telecommunications asset information management system of claim 1, wherein the network service comprises a local voice service.

5. The telecommunications asset information management system of claim 1, wherein the network service comprises a long distance service.

6. The telecommunications asset information management system of claim 1, wherein the network service comprises a mobile device service.

7. The telecommunications asset information management system of claim 1, wherein the network service comprises a conferencing service.

8. The telecommunications asset information management system of claim 1, wherein the network service comprises a data network service.

9. The telecommunications asset information management system of claim 1, wherein the network service comprises an asynchronous transport mode service.

10. The telecommunications asset information management system of claim 1, wherein the network service comprises a frame relay service.

11. The telecommunications asset information management system of claim 1, wherein the data entry object is incorporated into a browser-based user interface.

12. The telecommunications asset information management system of claim 1, wherein the database is a relational database.

13. The telecommunications asset information management system of claim 1, wherein the network is a global computer network.

14. The telecommunications asset information management system of claim 1, wherein the network is a local computer network.

15. The telecommunications asset information management system of claim 1, wherein the network is a virtual private network.

16. The telecommunications asset information management system of claim 1, wherein the display comprises a first computer-generated data interface that includes a plurality of primary customer premise equipment-specific data fields, each primary customer premise equipment-specific data field capable of receiving and displaying primary customer premise equipment-specific data relating to a primary telecommunications asset at a first location, the plurality of primary customer premise equipment-specific data input fields including:
a. a Port A identifier field;
b. a Port Z identifier field;
c. a frame relay identifier field;
d. a frame relay account identifier field; and
e. a frame relay provider name field.

17. The telecommunications asset information management system of claim 16, wherein the plurality of primary customer premise equipment-specific data input fields further includes:
a. a location of a Port A termination at a first location field; and
b. a location of a Port Z termination at a second location field.

18. The telecommunications asset information management system of claim 17, wherein the location of the Port A termination at the first location field and the location of the Port Z termination at the second location field are displayed as waterfall menus, each waterfall menu providing a plurality of predetermined allowable options for each field.

19. The telecommunications asset information management system of claim 17, wherein the network service comprises a private virtual circuit.

20. The telecommunications asset information management system of claim 16, wherein the plurality of primary customer premise equipment-specific data input fields further includes a primary telecommunications asset status indicator field.

21. The telecommunications asset information management system of claim 16, wherein the plurality of primary customer premise equipment-specific data input fields further includes an estimated monthly recurring charge amount field.

22. The telecommunications asset information management system of claim 16, wherein the plurality of primary customer premise equipment-specific data input fields further includes a configuration notes field.

23. The telecommunications asset information management system of claim 16, wherein the plurality of primary customer premise equipment-specific data input fields further includes a general notes field.

24. The telecommunications asset information management system of claim 16, wherein the first computer-generated data interface further includes a location data field that allows the user to select the first location from a predetermined plurality of locations.

25. The telecommunications asset information management system of claim 16, wherein the first computer-generated data interface further includes an interactive region that displays an identification of each of a plurality of primary telecommunications assets associated with the first location.

26. The telecommunications asset information management system of claim 1, further comprising a second computer-generated data interface that includes a plurality of secondary customer premise equipment-specific data fields, each secondary customer premise equipment-specific data field capable of receiving and displaying secondary customer premise equipment-specific data relating to a secondary telecommunications asset that is associated with a primary telecommunications asset, the plurality of secondary customer premise equipment-specific data input fields including:
a. a provider name field that identifies the provider of the secondary telecommunications asset; and
b. a circuit identification field that identifies the circuit designation assigned by the provider to the telecommunications asset.

27. The telecommunications asset information management system of claim 26, wherein the plurality of secondary customer premise equipment-specific data input fields further includes a user-assigned access name field that identifies the secondary telecommunications asset.

28. The telecommunications asset information management system of claim 26, wherein the plurality of secondary customer premise equipment-specific data input fields further includes a demarcation location data field that identifies a physical location of a termination point of the secondary telecommunications asset.

29. The telecommunications asset information management system of claim 26, wherein the plurality of secondary customer premise equipment-specific data input fields further includes:
a. a signaling type data field that identifies a signaling type employed by the secondary telecommunications asset;
b. a trunk type data field that identifies a trunk type employed by the secondary telecommunications asset;
c. a framing type data field that identifies a framing type employed by the secondary telecommunications asset; and
d. a line coding type data field that identifies a line coding standard employed by the secondary telecommunications asset.

30. The telecommunications asset information management system of claim 26, wherein the plurality of secondary customer premise equipment-specific data input fields further includes
a. an install date data field that identifies a date on which the secondary telecommunications asset was installed; and
b. an activation date data field that identifies a date on which the secondary telecommunications asset was activated.

31. The telecommunications asset information management system of claim 1, further comprising a third computer-generated data interface that includes a plurality of tertiary telecommunications equipment-specific data fields, each telecommunications equipment-specific data field capable of receiving and displaying telecommunications equipment-specific data relating to a telecommunications equipment asset that is associated with a primary telecommunications asset, the plurality of tertiary telecommunications equipment-specific data fields including:
a. an equipment category indicator field that accepts a category describing the telecommunications equipment asset;
b. an equipment type indicator field that accepts an equipment type describing the telecommunications equipment asset;
c. a serial number field that accepts a serial number for the telecommunications equipment asset; and
d. a model name field that accepts a model name for the telecommunications equipment asset.

32. The telecommunications asset information management system of claim 31, wherein the plurality of tertiary telecommunications equipment-specific data fields further includes:
a. a purchase date field that accepts a purchase date for the telecommunications equipment asset; and
b. an installation date field that accepts an installation date for the telecommunications equipment asset.

33. The telecommunications asset information management system of claim 31, wherein the plurality of tertiary telecommunications equipment-specific data fields further includes a purchase price field that accepts a purchase price for the telecommunications equipment.

34. The telecommunications asset information management system of claim 31, wherein the plurality of tertiary telecommunications equipment-specific data fields further includes a configuration notes field that accepts configuration information relating to the telecommunications equipment asset.

35. The telecommunications asset information management system of claim 31, wherein the plurality of tertiary telecommunications equipment-specific data fields further includes a warranty notes field that allows input of warranty information relating to the telecommunications equipment asset.

36. The telecommunications asset information management system of claim 1, further comprising a fourth computer-generated data interface that includes a plurality of mobile device data fields, each associated with a mobile device, including:
a. a mobile telephone number field that identifies a telephone number of the mobile device;
b. a mobile provider identification field that identifies a mobile service provider associated with the mobile device;
c. a mobile service plan identifier field that identifies a mobile service plan associated with the mobile device; and
d. a mobile plan account number field that identifies an account number associated with the mobile device.

37. The telecommunications asset information management system of claim 36, wherein the plurality of mobile device data fields further includes:
a. a mobile device user identification field that identifies a mobile device user; and
b. a mobile device user contact information field that stores contact information associated with the mobile device user.

38. The telecommunications asset information management system of claim 36, wherein the plurality of mobile device data fields further includes:
a. a mobile device manufacturer identification field that identifies a manufacturer of the mobile device;
b. a mobile device model identification field that identifies a model of the mobile device; and
c. a mobile device serial number identification field that identifies a serial number of the mobile device.

39. The telecommunications asset information management system of claim 36, wherein the plurality of mobile device data fields further includes a mobile device cost information field that indicates cost information associated with the mobile device.

40. The telecommunications asset information management system of claim 36, wherein the plurality of mobile device data fields further includes a mobile device account information field that indicates account information associated with the mobile device.

41. The telecommunications asset information management system of claim 1, further comprising a fifth computer-generated data interface that includes a global inventory listing of all telecommunications assets owned by the entity associated with the user.

42. The telecommunications asset information management system of claim 41, wherein the system is capable of sorting the global inventory listing by provider name.

43. The telecommunications asset information management system of claim 41, wherein the system is capable of sorting the global inventory listing by service type.

44. The telecommunications asset information management system of claim 1, further comprising a sixth computer-generated data interface that includes a user activity listing that lists a plurality of activities performed by the user.

45. The telecommunications asset information management system of claim 1, further comprising a seventh computer-generated data interface that includes a billing activity listing that lists a plurality of billing activities associated with a telecommunications asset.

46. The telecommunications asset information management system of claim 1, further comprising an eighth computer-generated data interface that includes a contract listing that lists a plurality of telecommunications asset contract information units associated with telecommunications contracts to which the entity associated with the user is a party.

47. The telecommunications asset information management system of claim 1, further comprising an ninth computer-generated data interface that includes a plurality of links to computer-stored documents.

48. A method of managing, via a computer network accessible to a computer in communication with a display and operated by a user, information relating to a plurality of telecommunications assets, comprising the steps of:
a. generating on the display a first computer-generated data interface that includes a plurality of communications network-specific data fields, each communications network-specific data field capable of receiving and displaying communications network assets data associated with a first location;
b. transmitting to a server, at a second location that is remote from the first location, via the computer network, the communications network assets data;
c. instructing the server to store the communications network assets data in a database on the server; and
d. transmitting a request for communications network assets data to be displayed on the display; and
e. displaying on the display the communications network assets data after the communications network assets data is received from the server.

49. A method of managing, via a computer network accessible to a computer in communication with a display and operated by a user at a first location, information relating to a plurality of telecommunications assets, comprising the steps of:
a. receiving via a computer network and storing in a database at a location that is remote from the first location, customer premise equipment-specific data that is specific to a predetermined private virtual circuit in communication with a specific set of customer premise equipment employed by an entity associated with the user;
b. receiving from the user a request for customer premise equipment-specific data; and
c. transmitting to the user, in response to the receiving step, the customer premise equipment-specific data.

50. The method of claim 49, wherein the customer premise equipment-specific data includes:
a. a Port A identifier;
b. a Port Z identifier;
c. a frame relay identifier;
d. a frame relay account identifier; and
e. a frame relay provider name.
